(19) United States
(12) Patent Application Publication
(10) Pub. No.: US 2025/0308462 A1
(43) Pub. Date: Oct. 2, 2025

(54) DISPLAY DEVICE AND ELECTRONIC DEVICE

(71) Applicant: Samsung Display Co., LTD., Yongin-si (KR)

(72) Inventors: HYOJUNG KIM, Yongin-si (KR); SEUNGBO SHIM, Yongin-si (KR); Hyesun SUNG, Yongin-si (KR); JI-HYEON SON, Yongin-si (KR); JEONG YONG LEE, Yongin-si (KR); DEOK JUN CHOI, Yongin-si (KR)

(21) Appl. No.: 19/049,406

(22) Filed: Feb. 10, 2025

(30) Foreign Application Priority Data
Mar. 28, 2024 (KR) 10-2024-0042253

(51) Int. Cl. G09G 3/3266; G09G 3/32; G09G 3/3291

(52) U.S. Cl. CPC G09G 3/3266; G09G 3/32; G09G 3/3291; G09G 2300/0819; G09G 2310/0267; G09G 2310/0275; G09G 2310/08; G09G 2330/021

(57) ABSTRACT

A display device includes a display panel including a pixel, a data driver which supplies a data voltage, and a gate driver which outputs a first scan signal and a second scan signal. The pixel includes a light emitting element, a first transistor connected between the light emitting element and a first power line, a second transistor which is connected to the first transistor and receives the data voltage and the first scan signal, and a third transistor which is connected to a control electrode of the first transistor and receives the second scan signal. The data driver supplies the data voltage to the 10 pixel during a first period and supplies a bias voltage to the pixel during a second period. The second scan signal includes a second active period overlapping the first period and a compensation active period overlapping the second period.

This application claims priority to Korean Patent Application No. 10-2024-0042253, filed on Mar. 28, 2024, and all the benefits accruing therefrom under 35 U.S.C. § 119, the content of which in its entirety is herein incorporated by reference.

### BACKGROUND

### (1) Field

Embodiments of the disclosure described herein relate to a display device, and more particularly, relate to a display device with improved display quality and an electronic device including the display device.

### (2) Description of the Related Art

A light emitting display device among display devices displays an image by using a light emitting diode that generates a light through the recombination of electrons and holes. The light emitting display device has a fast response speed and operates with low power consumption.

The display device may include a display panel for displaying an image, a gate driver for sequentially supplying scan signals to scan lines included in the display panel, and a data driver for supplying data signals to data lines included in the display panel.

### SUMMARY

Embodiments of the disclosure provide a display device with improved display quality and an electronic device including the display device.

According to an embodiment, a display device includes a display panel including a pixel, a data driver which supplies a data voltage to the pixel, and a gate driver which supplies a first scan signal and a second scan signal to the pixel.

In such an embodiment, the pixel includes a light emitting element, a first transistor connected between the light emitting element and a first power line, a second transistor connected to the first transistor, where the second transistor receives the data voltage and the first scan signal, and a third transistor connected to a control electrode of the first transistor, where the third transistor receives the second scan signal.

In such an embodiment, the data driver supplies the data voltage to the pixel during a first period and supplies a bias voltage to the pixel during a second period. In such an embodiment, the second scan signal includes a second active period overlapping the first period and a compensation active period overlapping the second period.

In an embodiment, the compensation active period may have a duration equal to a duration of the second active period.

In an embodiment, the compensation active period may include a plurality of sub-compensation active periods, and each of the sub-compensation active periods may have a duration equal to a duration of the second active period.

In an embodiment, the first scan signal may include a first active period which overlaps the first period and the second period, and the first active period may have a duration shorter than a duration of the second active period.

In an embodiment, the first active period may include a first sub-active period overlapping the second active period or the compensation active period, and a second sub-active period not overlapping the second active period or the compensation active period.

In an embodiment, a start time point of the first sub-active period may follow a start time point of the second active period, and a start time point of the second sub-active period may follow an end time point of the second active period.

In an embodiment, the second transistor may include a first electrode connected to a data line, a second electrode connected to a first electrode of the first transistor, and a control electrode which receives the first scan signal. In such an embodiment, the third transistor may include a first electrode connected to the control electrode of the first transistor, a second electrode connected to a second electrode of the first transistor, and a control electrode which receives the second scan signal.

In an embodiment, the gate driver may further supply a third scan signal to the pixel. In such an embodiment, the pixel further includes a fourth transistor including a first electrode connected to the control electrode of the first transistor, a second electrode connected to an initialization voltage line, and a control electrode which receives the third scan signal.

In an embodiment, the display device may further include a light emitting driver which applies an emission control signal to the pixel.

In an embodiment, the emission control signal may include a first inactive period and a second inactive period which overlap the first period and the second period, respectively, and the second active period and the compensation active period overlap the first inactive period and the second inactive period, respectively.

In an embodiment, the gate driver may include a first scan circuit which outputs the first scan signal and a second scan circuit which outputs the second scan signal.

In an embodiment, the display device may further include a masking circuit connected to an output terminal of the second scan circuit to receive the second scan signal, where the masking circuit selectively masks an output of the second scan signal in response to a masking signal.

In an embodiment, the display panel may display an image during a plurality of frames. In such an embodiment, each of the plurality of frames includes the first period and the second period. In such an embodiment, The masking circuit masks the output of the second scan signal during the second period in response to the masking signal in units of k preset frames, where k is an integer equal to or greater than 2.

In an embodiment, the gate driver may further include a scan circuit which outputs a scan signal through an output terminal, and a switching circuit which receives the scan signal, outputs the scan signal as the first scan signal and the second scan signal during the first period, and outputs the scan signal as the second scan signal during the second period.

In an embodiment, the switching circuit may include a first switching element connected to the output terminal to receive the scan signal, turned on during the first period in response to a first switching signal to output the scan signal as the first scan signal, and turned off during the second period not to output the first scan signal, and a second switching element connected to the output terminal to receive the scan signal, and turned on during the first period and the second period in response to a second switching signal to output the scan signal as the second scan signal.

According to an embodiment, an electronic device includes a display device which provides an image. In such an embodiment, the display device includes a display panel including a pixel which displays an image during a plurality of frames, a data driver which supplies a data voltage to the pixel, a gate driver which supplies a first scan signal and a second scan signal to the pixel and a driving controller which receives a image signal and a control signal, and controls operations of the data driver and the gate driver.

In such an embodiment, the pixel includes a light emitting element, a first transistor connected between the light emitting element and a first power line, a second transistor connected to the first transistor, where the second transistor receives the data voltage and the first scan signal, and a third transistor connected to a control electrode of the first transistor, where the third transistor receives the second scan signal. In such an embodiment, each of the plurality of frames includes a first period and a plurality of second periods.

In such an embodiment, the data driver supplies the data voltage to the pixel during the first period and supplies a bias voltage to the pixel during the plurality of second periods. In such an embodiment, the second scan signal includes a second active period overlapping the first period and a compensation active period overlapping at least one of the plurality of second periods.

In an embodiment, the gate driver may include a first scan circuit which outputs the first scan signal and a second scan circuit which outputs the second scan signal.

In an embodiment, the electronic device may further include a masking circuit connected to an output terminal of the second scan circuit to receive the second scan signal, where the masking circuit selectively masks an output of the second scan signal in response to a masking signal.

In an embodiment, the masking circuit may output the second scan signal during at least one second period selected from the plurality of second periods in response to the masking signal, and mask the second scan signal in a way such that the second scan signal is not output during remaining second periods.

According to an embodiment, a display device includes a display panel including a pixel, a data driver which supplies a data voltage to the pixel, and a gate driver which supplies a first scan signal and a second scan signal to the pixel.

In such an embodiment, the pixel includes a light emitting element, a first transistor connected between the light emitting element and a first power line, a second transistor connected to the first transistor, where the second transistor receives the data voltage and the first scan signal, and a third transistor connected to a control electrode of the first transistor, where the third transistor receives the second scan signal.

In such an embodiment, the data driver supplies the data voltage to the pixel during a first period and supplies a bias voltage to the pixel during a second period.

In such an embodiment, each of the first period and the second period includes a valid period, a front porch period preceding the valid period, and a back porch period following the valid period.

In such an embodiment, the second scan signal includes a second active period overlapping the valid period of the first period, and a compensation active period overlapping at least one selected from the back porch period of the first period and the front porch period of the second period.

In an embodiment, the compensation active period may have a duration equal to a duration of the second active period, or have a longer duration than the duration of the second active period.

### BRIEF DESCRIPTION OF THE DRAWINGS

The above and other features of embodiments of the disclosure will become apparent by describing in detail embodiments thereof with reference to the accompanying drawings.

FIG. 1 is a block diagram of a display device, according to an embodiment of the disclosure.

FIG. 2 is a block diagram of a gate driver, according to an embodiment of the disclosure.

FIG. 3 is a circuit diagram of a pixel, according to an embodiment of the disclosure.

FIGS. 4A and 4B are signal timing diagrams for describing an operation of a pixel, according to embodiments of the disclosure.

FIG. 5 is a block diagram of a gate driver, according to an embodiment of the disclosure.

FIG. 6 is a signal timing diagram for describing an operation of a gate driver shown in FIG. 5.

FIG. 7 is a block diagram of a gate driver, according to an embodiment of the disclosure.

FIGS. 8A and 8B are signal timing diagrams for describing an operation of a masking circuit, according to embodiments of the disclosure.

FIGS. 9A to 9C are signal timing diagrams for describing an operation of a masking circuit, according to embodiments of the disclosure.

FIG. 10 is a signal timing diagram showing a compensation scan signals, according to an embodiment of the disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present.

In the specification, the expression that a first component (or region, layer, part, etc.) is “connected with”, or “coupled with” a second component means that the first component is connected with, or coupled with the second component or means that a third component is interposed therebetween.

Like reference numerals refer to like components. Also, in drawings, the thickness, ratio, and dimension of components are exaggerated for effectiveness of description of technical contents.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical terms and scientific terms) used in the specification have the same meaning as commonly understood by one skilled in the art to which the disclosure belongs. Furthermore, terms such as terms defined in commonly used dictionaries should be interpreted as having a meaning consistent with the meaning in the context of the related technology, and should not be interpreted in an overly ideal or overly formal sense unless explicitly defined herein.

Hereinafter, embodiments of the disclosure will be described with reference to accompanying drawings.

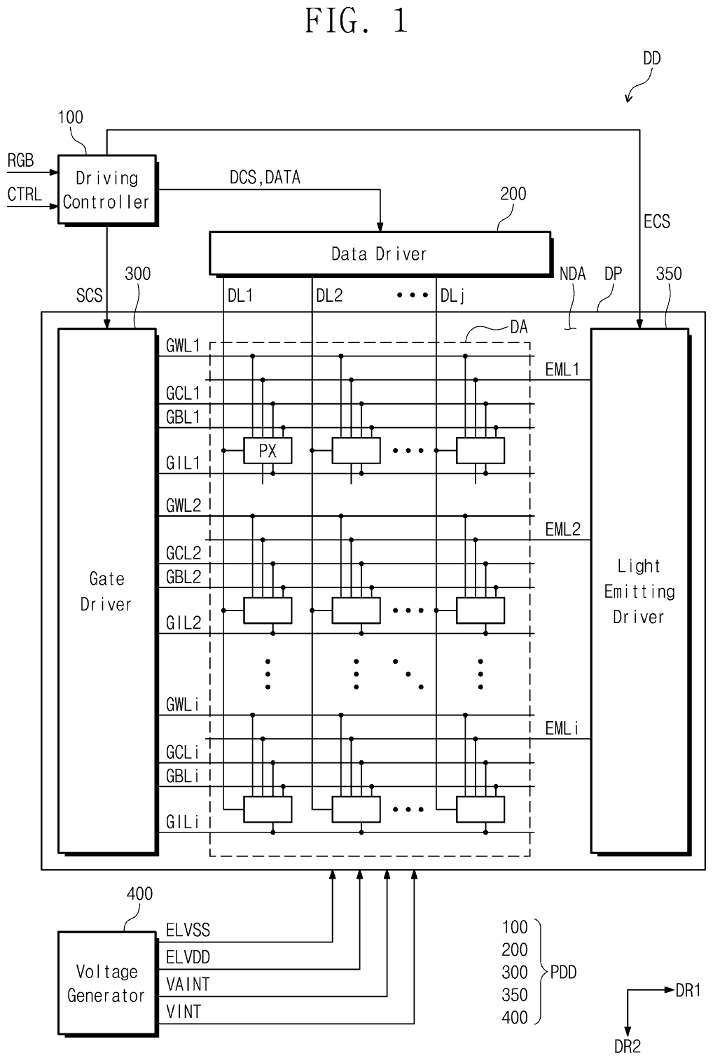

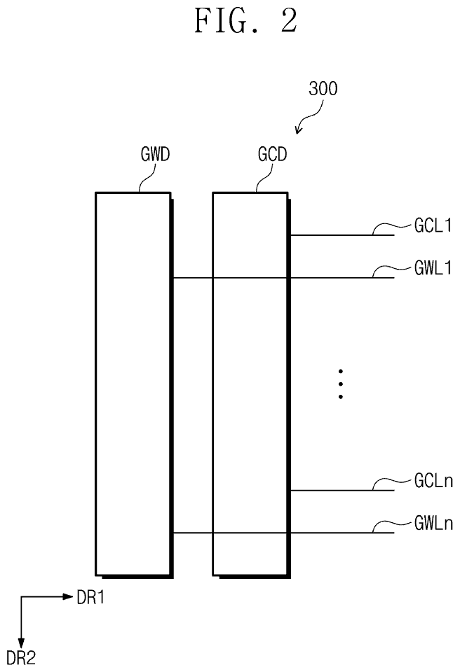

FIG. 1 is a block diagram of a display device DD, according to an embodiment of the disclosure. FIG. 2 is a block diagram of a gate driver 300, according to an embodiment of the disclosure.

Referring to FIG. 1, an embodiment of the display device DD may include a display panel DP and a panel driver PDD. In an embodiment of the disclosure, the panel driver PDD may include a driving controller 100, a data driver 200, a gate driver 300, a light emitting driver 350, and a voltage generator 400.

The display panel DP may include a display area DA and a non-display area NDA surrounding at least part of the display area DA. The display panel DP may include a plurality of pixels PX placed in the display area DA. The display panel DP may include write scan lines GWL1 to GWLi, compensation scan lines GCL1 to GCLi, initialization scan lines GIL1 to GILi, black scan lines GBL1 to GBLi, and emission control lines EML1 to EMLi. The write scan lines GWL1 to GWLi may be referred to as “first scan lines”. The compensation scan lines GCL1 to GCLi may be referred to as “second scan lines”. The initialization scan lines GIL1 to GILi may be referred to as “third scan lines”. The black scan lines GBL1 to GBLi may be referred to as “fourth scan lines”. Here, ‘i’ may be an integer (or a natural number) greater than 1.

The driving controller 100 receives an image signal RGB and a control signal CTRL. The driving controller 100 generates image data DATA by converting a data format of the image signal RGB in compliance with the specification for an interface with the data driver 200. The driving controller 100 outputs a first driving control signal SCS, a second driving control signal DCS, and a third driving control signal ECS.

The data driver 200 receives the second driving control signal DCS and the image data DATA from the driving controller 100. The data driver 200 converts image data DATA into data signals and outputs the data signals to data lines DLI to DLj. The data signals refer to analog voltages corresponding to grayscale values of the image data DATA. The data lines DLI to DLj may be arranged in a first direction DR1, and each of the data lines DLI to DLj may extend in a second direction DR2. Here, ‘j’ may be an integer (or a natural number) greater than 1.

The gate driver 300 receives the first driving control signal SCS from the driving controller 100. The gate driver 300 may be connected to the write scan lines GWL1 to GWLi, the compensation scan lines GCL1 to GCLi, the initialization scan lines GIL1 to GILi, and the black scan lines GBL1 to GBLi. The gate driver 300 may output write scan signals, compensation scan signals, initialization scan signals, and black scan signals to the write scan lines GWL1 to GWLi, the compensation scan lines GCL1 to GCLi, the initialization scan lines GIL1 to GILi, and the black scan lines GBL1 to GBLi in response to the first driving control signal SCS, respectively. The write scan signals may be referred to as “first scan signals”, the compensation scan signals may be referred to as “second scan signals”, the initialization scan signals may be referred to as “third scan signals”, and the black scan signals may be referred to as “fourth scan signals”.

Referring to FIG. 2, in an embodiment, the gate driver 300 may include a first scan circuit GWD and a second scan circuit GCD. The arrangement order of the first and second scan circuits GWD and GCD in the first direction DR1 is only an example and is not particularly limited thereto.

In an embodiment, as shown in FIG. 2, the first scan circuit GWD may be connected to the write scan lines GWL1 to GWLi to apply write scan signals to the write scan lines GWL1 to GWLi. In an embodiment of the disclosure, the first scan circuit GWD may be further connected to the black scan lines GBL1 to GBLi. In such an embodiment, the first scan circuit GWD may output some of the write scan signals as black scan signals.

The second scan circuit GCD may be connected to the compensation scan lines GCL1 to GCLi to apply compensation scan signals to the compensation scan lines GCL1 to GCLi. In an embodiment of the disclosure, the second scan circuit GCD may be further connected to the initialization scan lines GIL1 to GILi. In such an embodiment, the second scan circuit GCD may output some of the compensation scan signals as initialization scan signals.

Returning to FIG. 1, the light emitting driver 350 may be connected to the emission control lines EML1 to EMLi. The light emitting driver 350 may output emission control signals to the emission control lines EML1 to EMLi in response to the third driving control signal ECS from the driving controller 100.

The gate driver 300 and the light emitting driver 350 may be positioned in the non-display area NDA of the display panel DP. In an embodiment of the disclosure, the gate driver 300 is positioned adjacent to a first side (e.g., left) of the display area DA, and the light emitting driver 350 is placed adjacent to a second side (e.g., right) of the display area DA, which is different from the first side. In an embodiment of the disclosure, the second side may be opposite to the first side. In an embodiment, as shown in FIG. 1, the gate driver 300 and the light emitting driver 350 are respectively positioned on opposite sides of the display area DA, but the disclosure is not limited thereto. In another embodiment, for example, the gate driver 300 and the light emitting driver 350 may be positioned adjacent to one of the first side and the second side of the display panel DP. In an embodiment, the gate driver 300 and the light emitting driver 350 may be integrated into one circuit (circuitry or integrated circuit chip).

The voltage generator 400 (or a power supply unit) generates voltages necessary to operate the display panel DP. In an embodiment, the voltage generator 400 may generate a first driving voltage ELVDD, a second driving voltage ELVSS, a first initialization voltage VINT, and a second initialization voltage VAINT.

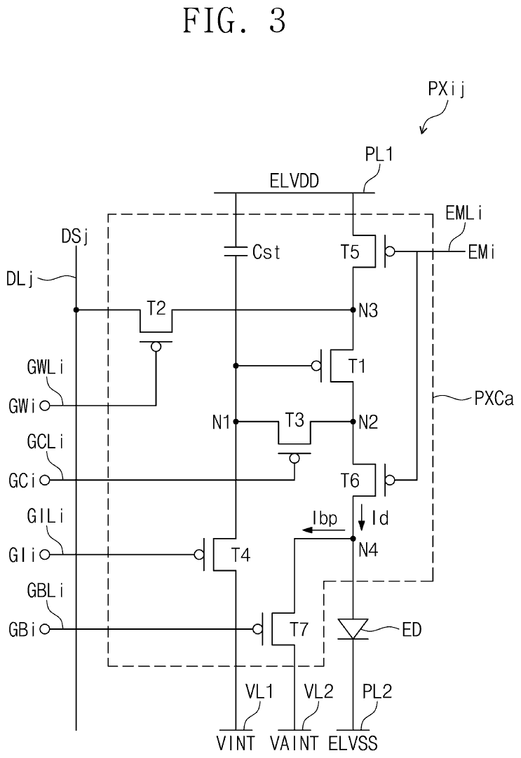

Each of a plurality of pixels PX includes a light emitting element ED (see FIG. 3) and a pixel circuit PXCa (see FIG. 3) that controls light emission of the light emitting element ED (see FIG. 3). The pixel circuit PXCa may include at least one or more transistors and at least one or more capacitors. The gate driver 300 and the light emitting driver 350 may include transistors formed through a same process as the pixel circuit PXCa. The pixel circuit PXCa may be referred to as a “pixel driver”.

The plurality of pixels PX may be electrically connected to the write scan lines GWL1 to GWLi, the compensation scan lines GCL1 to GCLi, the initialization scan lines GIL1 to GILi, the emission control lines EML1 to EMLi, and the data lines DLI to DLj. In an embodiment, for example, the i-th row of pixels may be connected to the i-th write, compensation, initialization and black scan lines GWLi, GCLi, GILi, and GBLi, and i-th emission control line EMLi. The j-th column of pixels may be connected to the j-th data line DLj. However, an embodiment is not limited thereto. In an embodiment, for example, each of the plurality of pixels PX may be connected to scan lines of which the number is greater than four.

Each of the plurality of pixels PX may be connected to a first power line PL1 (see FIG. 3), a second power line PL2 (see FIG. 3), a first initialization voltage line VL1 (see FIG. 3), and a second initialization voltage line VL2 (see FIG. 3). The first power line PL1 receives the first driving voltage ELVDD from the voltage generator 400. The second power line PL2 receives the second driving voltage ELVSS from the voltage generator 400. The first initialization voltage line VL1 receives the first initialization voltage VINT from the voltage generator 400. The second initialization voltage line VL2 receives the second initialization voltage VAINT from the voltage generator 400.

The write scan lines GWL1 to GWLi, the compensation scan lines GCL1 to GCLi, the initialization scan lines GIL1 to GILi, the black scan lines GBL1 to GBLi, and the emission control lines EML1 to EMLi may extend in the first direction DR1. The write scan lines GWL1 to GWLi, the compensation scan lines GCL1 to GCLi, the initialization scan lines GIL1 to GILi, the black scan lines GBL1 to GBLi, and the emission control lines EML1 to EMLi may be spaced from each other in the second direction DR2.

FIG. 3 is a circuit diagram of a pixel PXij, according to an embodiment of the disclosure.

FIG. 3 shows the pixel PXij connected to the i-th write scan line GWLi among the write scan lines GWL1 to GWLi (see FIG. 1) and the j-th data line DLj among the plurality of data lines DLI to DLj (see FIG. 1) as an example. The pixel PXij is connected to the i-th compensation scan line GCLi among the compensation scan lines GCL1 to GCLi (see FIG. 1), is connected to the i-th initialization scan line GILi among the initialization scan lines GIL1 to GILi (see FIG. 1), is connected to the i-th black scan line GBLi among the black scan lines GBL1 to GBLi, and is connected to the i-th emission control line EMLi (see FIG. 1) among the emission control lines EML1 to EMLi.

The pixel PXij may include the pixel circuit PXCa (or a pixel driving circuit) and the light emitting element ED electrically connected to the pixel circuit PXCa. In an embodiment, the pixel circuit PXCa may include seven transistors (first to seventh transistors T1 to T7), and one capacitor Cst. Each of the first to seventh transistors T1 to T7 may be a transistor having a low-temperature polycrystalline silicon (LTPS) semiconductor layer. In an embodiment, all of the first to seventh transistors T1 to T7 may be P-type transistors. However, the disclosure is not limited thereto. In another embodiment, for example, all of the first to seventh transistors T1 to T7 may be N-type transistors. In an embodiment, some (e.g., at least one) of the first to seventh transistors T1 to T7 may be P-type transistors, and the other(s) thereof may be N-type transistors. In an embodiment, for example, among the first to seventh transistors T1 to T7, the first, second, and fifth to seventh transistors T1, T2, and T5 to T7 are P-type transistors, and the third and fourth transistors T3 and T4 may be N-type transistors by using an oxide semiconductor as a semiconductor layer.

The i-th write scan line GWLi transmits an i-th write scan signal GWi to the pixel PXij. The i-th compensation scan line GCLi transmits an i-th compensation scan signal GCi to the pixel PXij. The i-th initialization scan line GILi transmits the i-th initialization scan signal Gli to the pixel PXij. The i-th black scan line GBLi transmits the i-th black scan signal GBi to the pixel PXij. The i-th emission control line EMLi may transmit the i-th emission control signal EMi to the pixel PXij. The j-th data line DLj may transmit the j-th data signal DSj to the pixel PXij. The j-th data signal DSj may have a voltage level corresponding to a grayscale value of the image data DATA (see FIG. 1) output from the driving controller 100 (see FIG. 1).

The pixel PXij may be connected to the first power line PL1 for receiving the first driving voltage ELVDD, the second power line PL2 for receiving the second driving voltage ELVSS, the first initialization voltage line VL1 for receiving the first initialization voltage VINT, and the second initialization voltage line VL2 for receiving the second initialization voltage VAINT. The first driving voltage ELVDD may have a higher voltage level than the second driving voltage ELVSS.

The light emitting element ED may include an anode and a cathode. In an embodiment where the light emitting element ED is an organic light emitting element, the light emitting element ED may further include an organic layer disposed between an anode and a cathode. The anode of the light emitting element ED may be connected to the pixel circuit PXCa. The cathode of the light emitting element ED may be connected to the second power line PL2. The light emitting element ED may emit light with an intensity corresponding to the amount of current flowing in the first transistor T1 of the pixel circuit PXCa.

The first transistor T1 is connected between the first power line PL1 for receiving the first driving voltage ELVDD, and the anode of the light emitting element ED. The first transistor T1 may be referred to as a driving transistor. The first transistor T1 may include a first electrode, a second electrode, and a gate electrode. The gate electrode (or a control electrode) of the first transistor T1 may be connected to a first node N1, the first electrode of the first transistor T1 may be connected to a third node N3, and the second electrode of the first transistor T1 may be connected to a second node N2. The first electrode may be referred to as a “source of the first transistor T1”. The second electrode may be referred to as a “drain of the first transistor T1”. The first transistor T1 may receive the j-th data signal DSj transmitted by the j-th data line DLj depending on the switching operation of the second transistor T2 and then may supply a driving current Id to the light emitting element ED.

The second transistor T2 is connected between the j-th data line DLj and the third node N3 to receive the i-th write scan signal GWi. The second transistor T2 may be referred to as a “switching transistor”. The second transistor T2 may include a first electrode connected to the j-th data line DLj, a second electrode connected to the third node N3, and a gate electrode connected to the i-th write scan line GWLi. The second transistor T2 may be turned on in response to the i-th write scan signal GWi received through the i-th write scan line GWLi and may transmit the j-th data signal DSj transmitted from the j-th data line DLj to the first electrode of the first transistor T1.

The third transistor T3 is connected between the second node N2 and the first node N1 to receive the i-th compensation scan signal GCi. The third transistor T3 may be referred to as a “compensation transistor”. The third transistor T3 may include a first electrode connected to the second node N2, a second electrode connected to the first node N1, and a gate electrode connected to the i-th compensation scan line GCLi. The third transistor T3 may be turned on in response to the i-th compensation scan signal GCi received through the i-th compensation scan line GCLi, and thus, the gate electrode and the second electrode of the first transistor T1 may be connected to each other, that is, the first transistor T1 may be diode-connected.

The fourth transistor T4 is connected between the first initialization voltage line VL1 and the first node N1 to receive the i-th initialization scan signal Gli. The fourth transistor T4 may include a first electrode connected to the first initialization voltage line VL1, a second electrode connected to the first node N1, and a gate electrode connected to the i-th initialization scan line GILi. The fourth transistor T4 is turned on in response to the i-th initialization scan signal Gli received through the i-th initialization scan line GILi such that the first initialization voltage VINT is transmitted to the gate electrode of the first transistor T1. Accordingly, an initialization operation may be performed to initialize the potential of the gate electrode (i.e., the first node N1) of the first transistor T1.

The fifth transistor T5 includes a first electrode connected to the first power line PL1, a second electrode connected to the first electrode of the first transistor T1, and a gate electrode connected to the i-th emission control line EMLi.

The sixth transistor T6 includes a first electrode connected to the second electrode of the first transistor T1, a second electrode connected to the anode of the light emitting element ED, and a gate electrode connected to the i-th emission control line EMLi.

The fifth transistor T5 and the sixth transistor T6 are simultaneously turned on in response to the i-th emission control signal EMi received through the i-th emission control line EMLi. The first driving voltage ELVDD applied through the fifth transistor T5 thus turned on may be compensated through the diode-connected first transistor T1 and then may be transmitted to the light emitting element ED.

The seventh transistor T7 may be connected between the second initialization voltage line VL2, which provides the second initialization voltage VAINT, and the anode (i.e., a fourth node N4) of the light emitting element ED to receive the i-th black scan signal GBi. The seventh transistor T7 may include a first electrode connected to the second initialization voltage line VL2, a second electrode connected to the anode of the light emitting element ED, and a gate electrode connected to the i-th black scan line GBLi. The seventh transistor T7 is turned on in response to the i-th black scan signal GBi received through the i-th black scan line GBLi to transmit the second initialization voltage VAINT to the anode (i.e., the fourth node N4) of the light emitting element ED. FIG. 3 shows an embodiment having a structure in which the seventh transistor T7 is connected to the i-th black scan line GBLi, but the disclosure is not limited thereto. In another embodiment, for example, the seventh transistor T7 is connected to an (i−1)-th write scan line to receive an (i−1)-th write scan signal as the i-th black scan signal GBi.

The capacitor Cst may be connected between the first power line PL1, which provides the first driving voltage ELVDD, and the first node N1. The capacitor Cst may include a first electrode connected to the first power line PL1 and a second electrode connected to the first node N1. The capacitor Cst may store a difference voltage (or a difference in electric potential) between the first power line PL1 and the first node N1.

The first node N1 may be defined as a node to which the gate electrode of the first transistor T1, the second electrode of the third transistor T3, the first electrode of the fourth transistor T4, and the second electrode of the capacitor Cst are connected.

The second node N2 may be defined as a node to which the second electrode of the first transistor T1, the first electrode of the third transistor T3, and the first electrode of the sixth transistor T6 are connected.

The third node N3 may be defined as a node to which the first electrode of the first transistor T1, the second electrode of the second transistor T2, and the second electrode of the fifth transistor T5 are connected.

The fourth node N4 may be defined as a node connected to the second electrode of the sixth transistor T6, the second electrode of the seventh transistor T7, and the anode of the light emitting element ED.

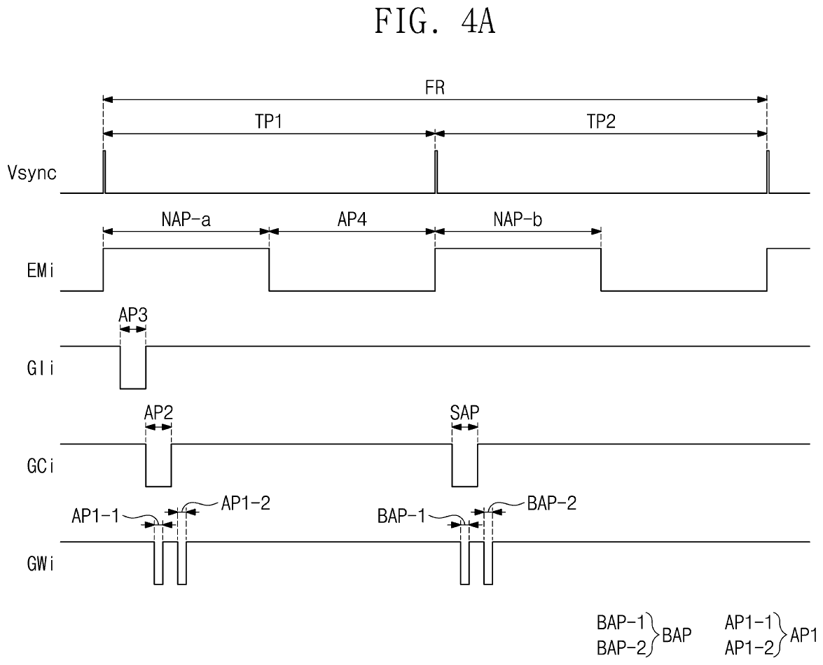

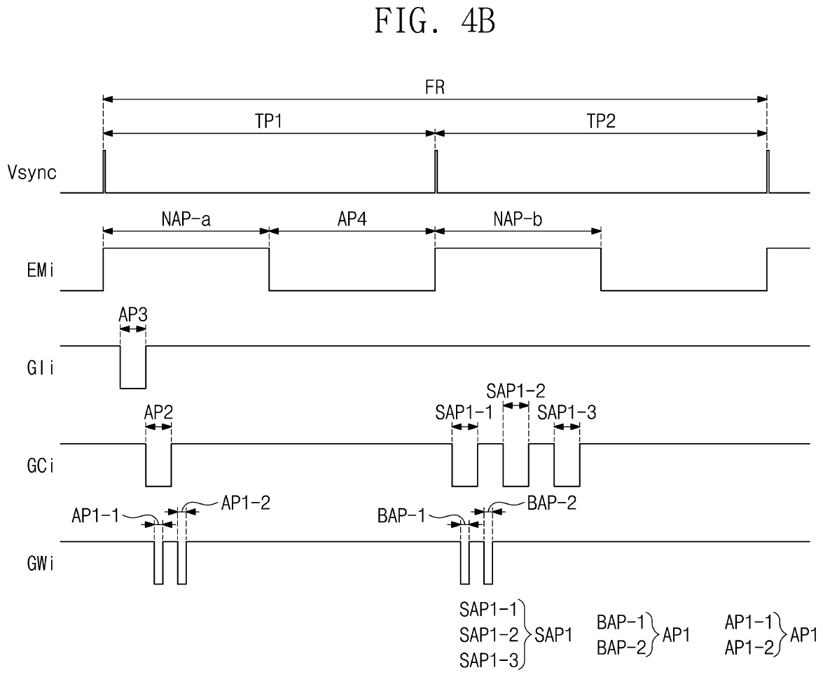

FIGS. 4A and 4B are signal timing diagrams for describing an operation of the pixel PXij, according to embodiments of the disclosure.

Referring to FIGS. 3 and 4A, in an embodiment, the pixel PXij may display an image in one frame FR (or every frame period). The frame FR may include a first period TP1 and at least one second period TP2. The first period TP1 may be a period for supplying a data voltage to the pixels PX. The second period TP2 may be a period for supplying a bias voltage to the pixels PX. FIG. 4A shows an embodiment in which the one second period TP2 is included in the frame FR, but the disclosure is not limited thereto. In another embodiment, for example, the frame FR may include the two or more second periods TP2.

The start time of each of the first period TP1 and the second period TP2 may be determined in response to a display synchronization signal Vsync (or referred to as a vertical synchronization signal). In an embodiment of the disclosure, the duration (or temporal length) of the first period TP1 may be the same as the duration of the second period TP2. In a variable frequency mode, the period of the display synchronization signal Vsync may be varied depending on the frame rate. When the period of the display synchronization signal Vsync is changed, the duration of each of the first period TP1 and the second period TP2 may also be varied in response to the period of the display synchronization signal Vsync.

Each of the i-th write scan signal GWi, the i-th compensation scan signal GCi, the i-th initialization scan signal Gli, and the i-th emission control signal EMi may have an active level (or a low level) during some periods (i.e., an activation period), and may have an inactive level (or a high level) during the remaining periods (i.e., a deactivation period). In an embodiment where the seven transistors T1 to T7 described above are P-type transistors, the active level of each of the i-th write scan signal GWi, the i-th compensation scan signal GCi, the i-th initialization scan signal Gli, and the i-th emission control signal EMi may be at a low level. Alternatively, where the seven transistors T1 to T7 are N-type transistors, the active level of each of the i-th write scan signal GWi, the i-th compensation scan signal GCi, the i-th initialization scan signal Gli, and the i-th emission control signal EMi may be at a high level.

During the first period TP1, the i-th emission control signal EMi may include a first inactive period NAP-a having an inactive level (e.g., a high level).

The i-th write scan signal GWi may include a first active period AP1, which overlaps the first period TP1 and has an active level (e.g., a low level). The first active period AP1 may overlap the first inactive period NAP-a of the i-th emission control signal EMi. In an embodiment of the disclosure, the first active period AP1 may include a first sub-active period AP1-1 and a second sub-active period AP1-2, but the disclosure is not limited thereto. In another embodiment, for example, the first active period AP1 may include only the second sub-active period AP1-2. The duration of the first sub-active period AP1-1 may be the same as the duration of the second sub-active period AP1-2.

The i-th compensation scan signal GCi may include a second active period AP2, which overlaps the first period TP1 and has an active level (e.g., a low level). The second active period AP2 may (temporally) overlap the first inactive period NAP-a of the i-th emission control signal EMi. In an embodiment of the disclosure, the second active period AP2 may overlap the first sub-active period AP1-1 and may not overlap the second sub-active period AP1-2. In other words, the start time point of the first sub-active period AP1-1 may follow the start time point of the second active period AP2. The start time point of the second sub-active period AP1-2 may follow the end time point of the second active period AP2. The duration of the first sub-active period AP1-1 and the duration of the second sub-active period AP1-2 may each be shorter than the duration of the second active period AP2.

The i-th initialization scan signal Gli may include a third active period AP3, which overlaps the first period TP1 and has an active level (e.g., a low level). The third active period AP3 may overlap the first inactive period NAP-a. The start time point of the third active period AP3 may follow the start time point of an inactive period NAP-a of the i-th emission control signal EMi. In an embodiment of the disclosure, the third active period AP3 precedes the second active period AP2 and may not overlap the second active period AP2. The duration of the third active period AP3 may be the same as the duration of the second active period AP2. In an embodiment, the end time point of the third active period AP3 may be the same as the start time point of the second active period AP2. However, the disclosure is not limited thereto. In another embodiment, for example, there may be a delay between the end time point of the third active period AP3 and the start time point of the second active period AP2.

During the third active period AP3, the fourth transistor T4 is turned on in response to the i-th initialization scan signal Gli. The first initialization voltage VINT is transmitted to the gate electrode of the first transistor T1 through the turned-on fourth transistor T4, and the gate electrode of the first transistor T1 is initialized by the first initialization voltage VINT. Accordingly, the third active period AP3 may be referred to as an “initialization period”.

During the second active period AP2, the third transistor T3 is turned on in response to the i-th compensation scan signal GCi. Accordingly, the first transistor T1 is diode-connected by the third transistor T3 thus turned on to be forward-biased. Accordingly, during the second active period AP2, the threshold voltage (Vth) of the first transistor T1 may be reflected to the gate electrode of the first transistor T1. In other words, the second active period AP2 may be referred to as a “compensation period” in which the threshold voltage (Vth) of the first transistor T1 is compensated.

During the first active period AP1, the second transistor T2 is turned on in response to the i-th write scan signal GWi. Then, a compensation voltage “DSj-Vth” obtained by reducing the j-th data signal DSj supplied from the j-th data line DLj by the threshold voltage (Vth) of the first transistor T1 is applied to the gate electrode of the first transistor T1. That is, the j-th data signal DSj may be written to the gate electrode of the first transistor T1. Accordingly, the first active period AP1 may be referred to as a “data write period”

During the first period TP1, the i-th emission control signal EMi may further include a fourth active period AP4 having an active level (e.g., a low level). During the fourth active period AP4, the fifth and sixth transistors T5 and T6 are turned on in response to the i-th emission control signal EMi. Accordingly, during the fourth active period AP4, the driving current Id may flow between the first power line PL1 and the second power line PL2, and the light emitting element ED may emit light by the driving current Id. The fourth active period AP4 may be referred to as an “emission period.”

During the fourth active period AP4, the i-th write scan signal GWi, the i-th compensation scan signal GCi, and the i-th initialization scan signal Gli may have an inactive level (e.g., a high level). Accordingly, during the fourth active period AP4, the second to fourth transistors T2 to T4, and the seventh transistor T7 may each be in a turn-off state.

The first driving voltage ELVDD and the compensation voltage (DSj-Vth) may be respectively applied to opposite ends of the capacitor Cst, and charges corresponding to a voltage difference between the opposite ends of the capacitor Cst may be stored in the capacitor Cst. Accordingly, even when the j-th data signal is not applied through the second transistor T2 during the fourth active period AP4, the first transistor T1 may is turned on, and the light emitting element ED may emit light by the driving current Id.

In the meantime, the seventh transistor T7 is turned on by receiving the i-th black scan signal GBi at the active level through the i-th black scan line GBLi. A portion of the driving current Id may be drained through the seventh transistor T7 as a bypass current Ibp.

In a case where the pixel PXij displays a black image, when the light emitting element ED emits light even though the minimum driving current of the first transistor T1 flows as the driving current Id, the pixel PXij may not normally display a black image. Accordingly, the seventh transistor T7 in the pixel PXij according to an embodiment of the disclosure may drain (or disperse) a part of the minimum driving current of the first transistor T1 to a current path, which is different from a current path to the light emitting element ED, as the bypass current Ibp. Here, the minimum driving current of the first transistor T1 means the current flowing into the first transistor T1 under the condition that the first transistor T1 is turned off because the gate-source voltage (Vgs) of the first transistor T1 is less than the threshold voltage (Vth). As the minimum driving current (e.g., a current of 10 picoampere (pA) or less) flowing to the first transistor T1 is transferred to the light emitting element ED under the condition that the first transistor T1 is turned off, an image of a black gray scale is displayed. When the pixel PXij displays a black image, the bypass current Ibp has a relatively large influence on the minimum driving current. When the pixel PXij displays an image such as a normal image or a white image, the bypass current Ibp has little effect on the driving current Id. Accordingly, when a black image is displayed, a current that corresponds to a result of subtracting the bypass current Ibp flowing through the seventh transistor T7 from the driving current Id is provided to the light emitting element ED, and thus a black image may be clearly displayed. Accordingly, the pixel PXij may implement an accurate black grayscale image by using the seventh transistor T7, and thus a contrast ratio may be improved.

Next, the i-th emission control signal EMi supplied from the i-th emission control line EMLi has an active level. The fifth transistor T5 and the sixth transistor T6 are turned on in response to the i-th emission control signal EMi having an active level. Accordingly, a driving current Id corresponding to a voltage difference between the gate voltage of the gate electrode of the first transistor T1 and the first driving voltage ELVDD is generated and supplied to the light emitting element ED through the sixth transistor T6.

During the second period TP2, the i-th emission control signal EMi may include a second inactive period NAP-b having an inactive level.

During the second period TP2, the i-th write scan signal GWi may include a bias active period BAP having an active level, and the i-th compensation scan signal GCi may include a compensation active period SAP having an active level. The bias active period BAP and the compensation active period SAP may overlap the second period TP2. During the second period TP2, the i-th initialization scan signal Gli may be maintained at an inactive level.

In an embodiment of the disclosure, the duration of the compensation active period SAP may be the same as the duration of the second active period AP2.

The bias active period BAP may include a first sub-bias active period BAP-1 and a second sub-bias active period BAP-2. The first sub-bias active period BAP-1 may overlap the compensation active period SAP. The duration of the first sub-bias active period BAP-1 may be shorter than the compensation active period SAP. The start time point of the first sub-bias active period BAP-1 may follow the start time point of the compensation active period SAP.

The second sub-bias active period BAP-2 may not overlap the compensation active period SAP. The duration of the second sub-bias active period BAP-2 may be shorter than the compensation active period SAP. The start time point of the second sub-bias active period BAP-2 may follow the end time point of the compensation active period SAP.

During the compensation active period SAP, the third transistor T3 is turned on in response to the i-th compensation scan signal GCi. Accordingly, the first transistor T1 is diode-connected by the third transistor T3 thus turned on to be forward-biased. Accordingly, even in the second period TP2, a compensation operation in which the threshold voltage of the first transistor T1 is compensated may be performed through the compensation active period SAP.

During the bias active period BAP, the second transistor T2 is turned on in response to the i-th write scan signal GWi. Then, the bias voltage supplied from the data line DLj may be applied to the first electrode of the first transistor T1. Accordingly, deterioration of display quality that occur when the potential difference between the first and second electrodes of the first transistor T1 increases to be greater than or equal to a specific level due to magnetic hysteresis may be effectively prevented.

Referring to FIG. 4B, in another embodiment, the i-th emission control signal EMi may include the first inactive period NAP-a, which overlaps the first period TP1 and has an inactive level, and a second inactive period NAP-b, which overlaps the second period TP2 and has an inactive level.

The i-th compensation scan signal GCi may include the second active period AP2, which overlaps the first period TP1 and has an active level, and a compensation active period SAP1, which overlaps the second period TP2 and has an active level. The compensation active period SAPI may include the first, second, and third sub-compensation active periods SAP1-1, SAP1-2, and SAP1-3.

The duration of each of the first, second, and third sub-compensation active periods SAP1-1, SAP1-2, and SAP1-3 may be the same as the duration of the second active period AP2. Each of the first, second, and third sub-compensation active periods SAP1-1, SAP1-2, and SAP1-3 may overlap the second inactive period NAP-b.

As the i-th compensation scan signal GCi is activated in the second period TP2, the third transistor T3 is turned on in the second period TP2, and thus a compensation operation of compensating for the threshold voltage Vth of the first transistor T1 may be performed.

In an embodiment, as shown in FIG. 4B, the compensation active period SAPI may have the three sub-compensation active periods SAP1-1, SAP1-2, and SAP1-3. However, the compensation active period SAP1 may include two or four or more sub-compensation active periods. The number of times (or a compensation level) that the compensation operation of the first transistor T1 is performed may be determined depending on the number of sub-compensation active periods included in the compensation active period SAP1. Accordingly, the number of sub-compensation active periods included in the compensation active period SAP1 or the duration of the compensation active period SAPI may be appropriately selected depending on the degree to which the threshold voltage of the first transistor T1 is shifted.

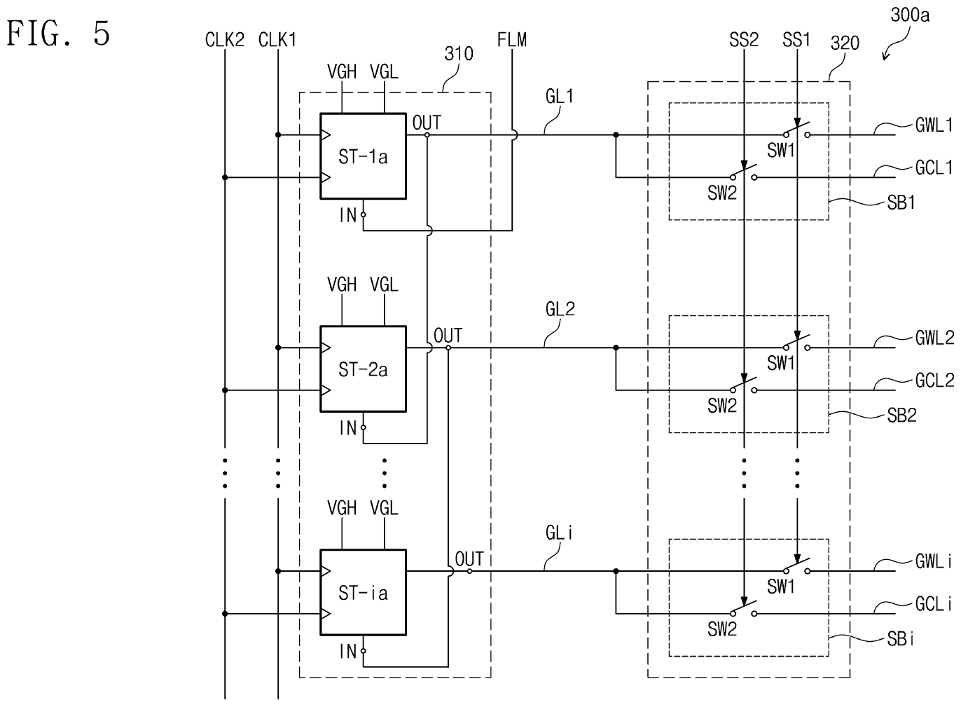

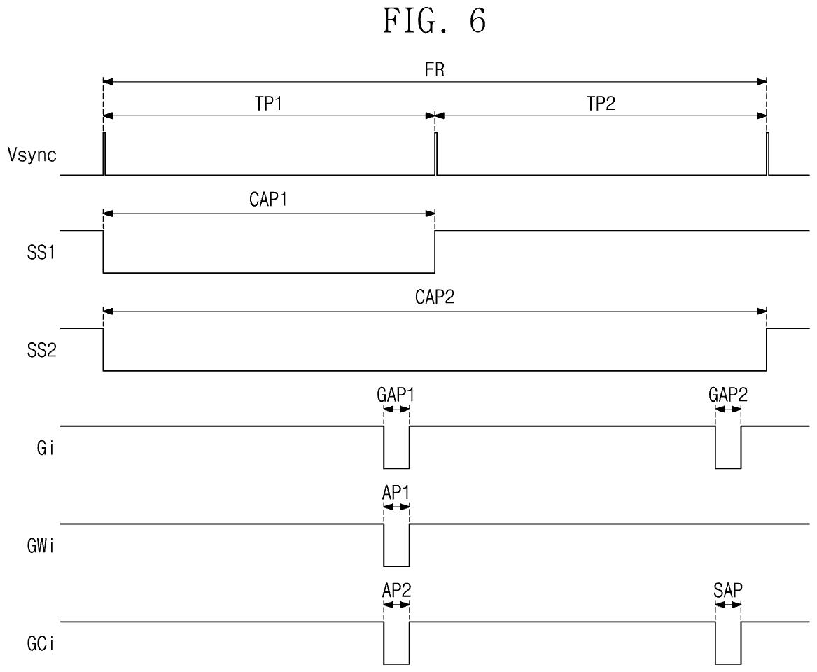

FIG. 5 is a block diagram of a gate driver 300a, according to an embodiment of the disclosure. FIG. 6 is a signal timing diagram for describing an operation of the gate driver 300a shown in FIG. 5.

Referring to FIG. 5, an embodiment of the gate driver 300a may include a scan circuit 310 and a switching circuit 320.

The scan circuit 310 includes a plurality of stages ST-la to ST-ia that respectively output scan signals.

Each of the stages ST-la to ST-ia receives the first driving control signal SCS (see FIG. 1) from the driving controller 100 (see FIG. 1). The first driving control signal SCS (see FIG. 1) may include a start signal FLM and first and second clock signals CLK1 and CLK2. Each of the stages ST-la to ST-ia further receive a first voltage VGH and a second voltage VGL. The first voltage VGH and the second voltage VGL may be provided from the voltage generator 400 (see FIG. 1).

The plurality of stages ST-la to ST-ia may be dependently (or cascadedly) connected to each other. Each of the plurality of stages ST-la to ST-ia may include an input terminal IN and an output terminal OUT. The input terminal IN of each of some stages ST-2a to ST-ia among the plurality of stages ST-la to ST-ia may receive a signal output from the previous stage as an input signal. The input terminal IN of the first stage ST-la among the plurality of stages ST-la to ST-ia may receive the start signal FLM as an input signal. The output terminals OUT of the plurality of stages ST-la to ST-ia may be respectively connected to the plurality of scan lines GL1 to GLi to output scan signals to the plurality of scan lines GL1 to GLi.

The switching circuit 320 is connected to the plurality of scan lines GL1 to GLi to receive scan signals. The switching circuit 320 may include a plurality of switching blocks SB1 to SBi. The plurality of switching blocks SB1 to SBi may be provided (or connected) to correspond to the plurality of scan lines GL1 to GLi, respectively. Each of the plurality of switching blocks SB1 to SBi includes a first switching element SW1 and a second switching element SW2.

The first switching element SW1 of the first switching block SB1 among the plurality of switching blocks SB1 to SBi is connected between the first scan line GL1 of the plurality of scan lines GL1 to GLi and the first write scan line GWL1 of the plurality of write scan lines GWL1 to GWLi. The second switching element SW2 of the first switching block SB1 is connected between the first scan line GL1 and the first compensation scan line GCL1 among the plurality of compensation scan lines GCL1 to GCLi.

The first switching element SW1 of the i-th switching block SBi among the plurality of switching blocks SB1 to SBi is connected between the i-th scan line GLi among the plurality of scan lines GL1 to GLi and the i-th write scan line GWLi among the plurality of write scan lines GWL1 to GWLi. The second switching element SW2 of the i-th switching block SBi is connected between the i-th scan line GLi and the i-th compensation scan line GCLi among the plurality of compensation scan lines GCL1 to GCLi.

The first switching elements SW1 of the plurality of switching blocks SB1 to SBi receive a first switching signal SS1. The first switching elements SW1 of the plurality of switching blocks SB1 to SBi may be turned on simultaneously in response to the first switching signal SS1. When the first switching elements SW1 is turned on, the scan lines GL1 to GLi are electrically connected to the plurality of write scan lines GWL1 to GWLi, respectively. Accordingly, the plurality of write scan lines GWL1 to GWLi may receive scan signals from the scan lines GL1 to GLi as write scan signals, respectively.

The second switching elements SW2 of the plurality of switching blocks SB1 to SBi may be turned on simultaneously in response to the second switching signal SS2. When the second switching elements SW2 are turned on, the scan lines GL1 to GLi are electrically connected to the plurality of compensation scan lines GCL1 to GCLi, respectively. Accordingly, the plurality of write scan lines GCL1 to GCLi may receive scan signals from the scan lines GL1 to GLi as compensation scan signals, respectively.

In an embodiment of the disclosure, each of the first and second switching elements SW1 and SW2 may include a transistor (or referred to as a “switching transistor”). The switching transistor may have a same type (e.g., P-type) of transistor as the transistors included in the pixel circuit PXCa (see FIG. 3).

Referring to FIGS. 5 and 6, the frame FR may include the first period TP1 and the at least one second period TP2. The first period TP1 may be a period for supplying a data voltage to the pixels PX. The second period TP2 may be a period for supplying a bias voltage to the pixels PX. FIG. 6 shows an embodiment in which the one second period TP2 is included in the frame FR, but the disclosure is not limited thereto. In another embodiment, for example, the frame FR may include the two or more second periods TP2.

The first switching signal SS1 may include a first switching active period CAP1 having an active level (e.g., a low level) during the first period TP1 and may have an inactive level (e.g., high level) during the second period TP2. The second switching signal SS2 may include a second switching active period CAP2 including an active level (e.g., a low level) during the first period TP1 and the second period TP2.

The i-th scan signal Gi may include a first scan active period GAP1, which overlaps the first period TP1 and has an active level (e.g., a low level). The i-th scan signal Gi may further include a second scan active period GAP2, which overlaps the second period TP2 and has an active level (e.g., a low level).

During the first period TP1, the i-th scan signal Gi is applied to the i-th write scan line GWLi as the i-th write scan signal GWi through the first switching element SW1 turned on in response to the first switching signal SS1. In the meantime, the first switching element SW1 is turned off in response to the first switching signal SS1 during the second period TP2, and thus the i-th scan signal Gi is not applied to the i-th write scan line GWLi. Accordingly, the i-th write scan signal GWi may include only the first active period AP1 overlapping the first period TP1. The first active period AP1 may overlap the first scan active period GAP1.

During the first period TP1, the i-th scan signal Gi is applied to the i-th compensation scan line GCLi as the i-th compensation scan signal GCi through the second switching element SW2 turned on in response to the second switching signal SS2. In the meantime, even during the second period TP2, the first switching element SW1 is turned on in response to the second switching signal SS2, and thus the i-th scan signal Gi is applied to the i-th compensation scan line GCLi. Accordingly, the i-th compensation scan signal GCi may include the second active period AP2 overlapping the first period TP1 and the compensation active period SAP overlapping the second period TP2. The second active period AP2 may overlap the first scan active period GAP1. The compensation active period SAP may overlap the second scan active period GAP2.

Even when the i-th write scan signal GWi and the i-th compensation scan signal GCi are output through a same scan circuit 310, only the i-th compensation scan signal GCi may be selectively activated by using the switching circuit 320 during the second period TP2.

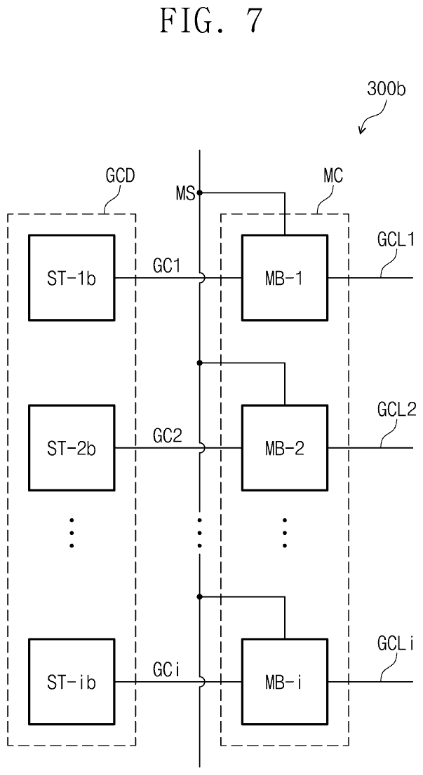

FIG. 7 is a block diagram of a gate driver 300b, according to an embodiment of the disclosure.

Referring to FIG. 7, an embodiment of a gate driver 300b may include the first scan circuit GWD (see FIG. 2), the second scan circuit GCD, and a masking circuit MC. In FIG. 7, the first scan circuit GWD is omitted for convenience of description.

The second scan circuit GCD outputs the compensation scan signals GC1 to GCi (or second scan signals). The masking circuit MC receives the compensation scan signals GC1 to GCi from the second scan circuit GCD.

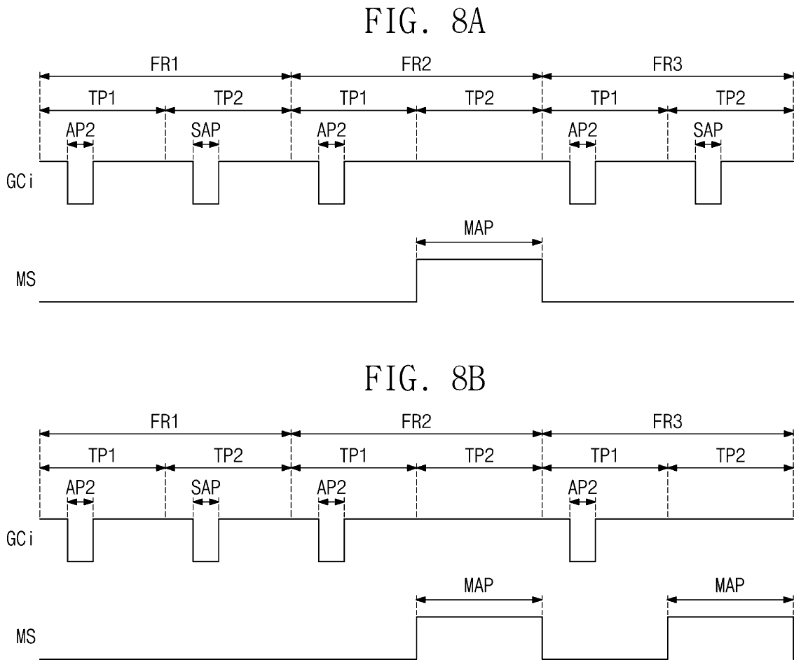

The masking circuit MC may further receive a masking signal MS. In an embodiment of the disclosure, the masking signal MS may be a signal supplied from the driving controller 100 (see FIG. 1). When the masking signal MS is supplied to the masking circuit MC, the masking circuit MC may block the output of the compensation scan signals GC1 to GCi received from the second scan circuit GCD. FIGS. 8A and 8B are signal timing diagrams for describing an operation of a masking circuit, according to embodiments of the disclosure.

Referring to FIG. 8A, three consecutive frames (hereinafter referred to as “first to third frames FR1, FR2, and FR3”) are shown. Each of the first to third frames FR1, FR2, and FR3 includes the first period TP1 and the second period TP2. The i-th compensation scan signal GCi may include the compensation active period SAP only in the second period TP2 of some frames (e.g., the first and third frames FR1 and FR3) among the first to third frames FR1, FR2, and FR3. In an embodiment, for example, during the second period TP2 of each of the first and third frames FR1 and FR3, the i-th compensation scan signal GCi may include the compensation active period SAP. In such an embodiment, during the second period TP2 of the second frame FR2, the i-th compensation scan signal GCi may not include the compensation active period SAP. As such, in the compensation active period SAP during the second period TP2, the first and third frames FR1 and FR3 including the compensation active period SAP may be referred to as “compensation frames”. In the compensation active period SAP during the second period TP2, the second frame FR2, which does not include the compensation active period SAP, may be referred to as a “non-compensation frame”.

As shown in FIGS. 7 and 8A, the masking signal MS may include a masking active period MAP that remains in an inactivated state during the first and third frames FR1 and FR3, which are referred to as compensation frames, and is activated during the second period TP2 of the second frame FR2, which is referred to as a non-compensation frame. During the masking active period MAP of the masking signal MS, the masking circuit MC may block the output of the compensation scan signals GC1 to GCi provided from the second scan circuit GCD. In the meantime, during the first and third frames FR1 and FR3 in each of which the masking signal MS is not activated, the masking circuit MC may output the compensation scan signals GC1 to GCi provided from the second scan circuit GCD.

Referring to FIG. 8B, the i-th compensation scan signal GCi may include the compensation active period SAP only in the second period TP2 of some frames (e.g., the first frame FR1) among the first to third frames FR1, FR2, and FR3. In an embodiment, for example, during the second period TP2 of the first frame FR1, the i-th compensation scan signal GCi may include the compensation active period SAP. In such an embodiment, during the second period TP2 of each of the second and third frames FR2 and FR3, the i-th compensation scan signal GCi may not include the compensation active period SAP. As such, in the compensation active period SAP during the second period TP2, the first frame FRI including the compensation active period SAP may be referred to as a “compensation frame”. In the compensation active period SAP during the second period TP2, the second and third frames FR2 and FR3, which do not include the compensation active period SAP, may be referred to as “non-compensation frames”.

As shown in FIGS. 7 and 8B, the masking signal MS may include a masking active period MAP that remains in an inactivated state during the first frame FR1, which is referred to as a compensation frame, and is activated during the second period TP2 of the second and third frames FR2 and FR3, which are referred to as non-compensation frames. During the masking active period MAP of the masking signal MS, the masking circuit MC may block the output of the compensation scan signals GC1 to GCi provided from the second scan circuit GCD. In the meantime, during the first frame FR1 in which the masking signal MS is not activated, the masking circuit MC may output the compensation scan signals GC1 to GCi provided from the second scan circuit GCD.

In an embodiment, as shown in FIGS. 8A and 8B, the i-th compensation scan signal GCi may have the compensation active period SAP once every two frames or once every three frames. However, the disclosure is not limited thereto. In another embodiment, for example, the i-th compensation scan signal GCi may have the compensation active period SAP once every k-th frame (‘k’ is an integer greater than 2).

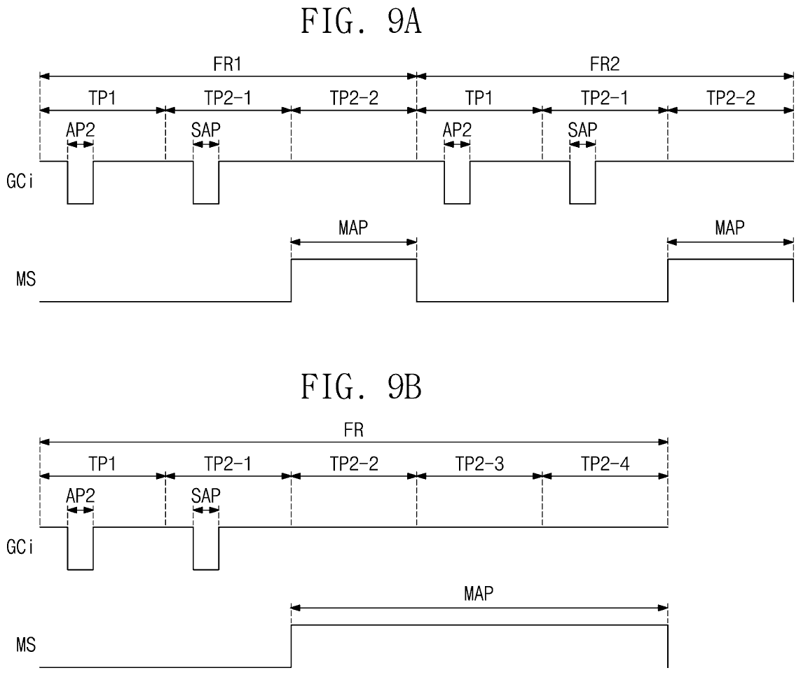

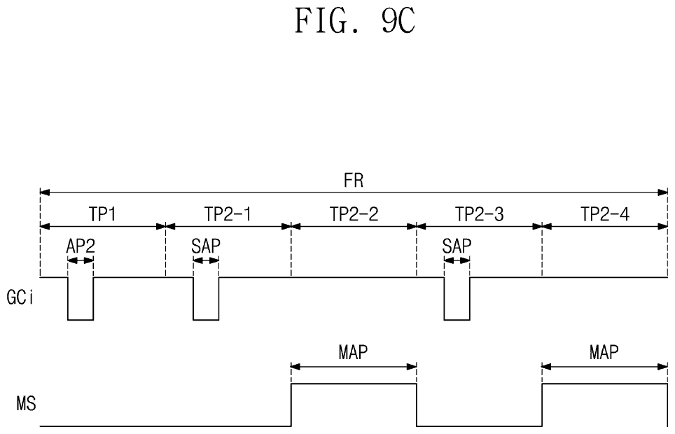

FIGS. 9A to 9C are signal timing diagrams for describing an operation of a masking circuit, according to embodiments of the disclosure.

Referring to FIG. 9A, in an embodiment, each of two consecutive frames (i.e., the first and second frames FR1 and FR2) may include one first period TP1 and two second periods including a first second period TP2-1 and a second period TP2-2 (hereinafter, will be referred to as a 2-1st period TP2-1 and a 2-2nd period TP2-2, respectively). The i-th compensation scan signal GCi includes the second active period AP2 in the first period TP1, and includes the compensation active period SAP in the 2-1st period TP2-1 following the first period TP1. In such an embodiment, as the masking signal MS includes the masking active period MAP during the 2-2nd period TP2-2 following the 2-1st period TP2-1, the i-th compensation scan signal GCi has an inactive level during the 2-2nd period TP2-2.

Referring to FIG. 9B, in another embodiment, each frame FR may include one first period TP1 and four second periods including a first second period TP2-1, a second second period TP2-2, a third second period TP2-3 and a fourth second period TP2-4 (hereinafter, will be referred to as a 2-1st period TP2-1, a 2-2nd period TP2-2, a 2-3rd period TP2-3, and a 2-4th period TP2-4, respectively). The i-th compensation scan signal GCi includes the second active period AP2 in the first period TP1 and includes the compensation active period SAP in the 2-1st period TP2-1 following the first period TP1. In such an embodiment, as the masking signal MS includes the masking active period MAP during the 2-2st, 2-3rd, and 2-4th periods TP2-2, TP2-3, and TP2-4, which consecutively follow the 2-1st period TP2-1, the i-th compensation scan signal GCi has an inactive level during the 2-2st, 2-3rd, and 2-4th periods TP2-2, TP2-3, and TP2-4.

As shown in FIG. 9C, in another embodiment, the i-th compensation scan signal GCi may include the compensation active period SAP during the 2-1st period TP2-1 and the 2-3rd period TP2-3. As the masking signal MS includes the masking active period MAP during the 2-2nd period TP2-2 following the 2-1st period TP2-1 and the 2-4th period TP2-4 following the 2-3rd period TP2-3, the i-th compensation scan signal GCi has an inactive level during the 2-2nd period TP2-2 and the 2-4th period TP2-4.

In an embodiment, as described above, where the one frame FR includes a plurality of second periods, the compensation active period SAP of the i-th compensation scan signal GCi may overlap some second periods among the plurality of second periods. That is, compared to a case where the compensation active period SAP of the i-th compensation scan signal GCi is provided during a plurality of second period, power consumption may be reduced by adjusting the number of second periods in each of which the compensation active period SAP is provided.

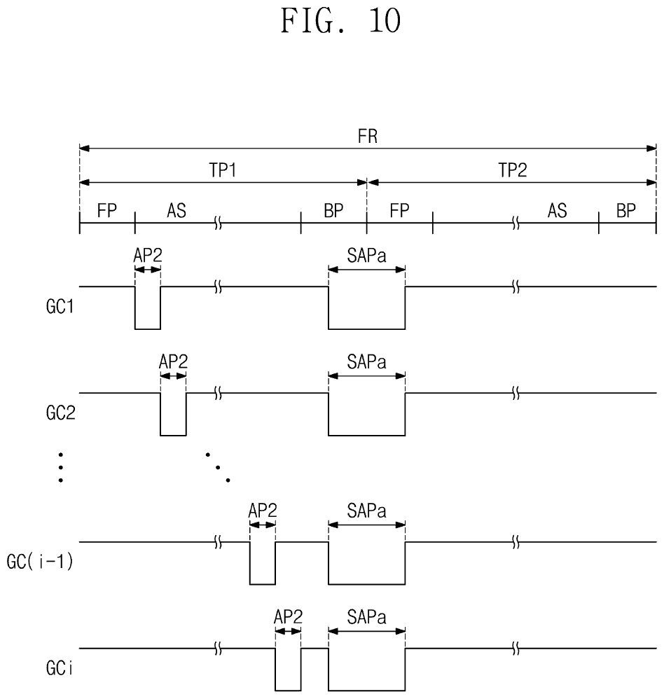

FIG. 10 is a signal timing diagram showing a compensation scan signals GC1 to GCi, according to an embodiment of the disclosure.

Referring to FIG. 10, each frame FR may include the first period TP1 and the second period TP2. Each of the first and second periods TP1 and TP2 may include a front porch period FP, a valid (or data writing) period AS, and a back porch period BP. During the valid period AS, the data signal DSj (see FIG. 3) may be written to the pixel PXij (see FIG. 3). The front porch period FP and the back porch period BP may be periods provided (or assigned) before and after the valid period AS, respectively. During the front porch period FP and the back porch period BP, the data signal DSj may not be written in the pixel PXij.

Referring to FIG. 10, during the valid period AS of the first period TP1, each of the compensation scan signals GC1 to GCi may include the second active period AP2 having an active level. When the second active period AP2 of the first compensation scan signal GC1 occurs during the valid period AS, the second active period AP2 of the second compensation scan signal GC2 is subsequently generated. Accordingly, the second active period AP2 of the i-th compensation scan signal GCi may follow the second active period AP2 of a (i−1)-th compensation scan signal GC (i−1). That is, the compensation scan signals GC1 to GCi may be sequentially provided to the compensation scan lines GCL1 to GCLi.

In an embodiment, each of the compensation scan signals GC1 to GCi may include a compensation active period SAPa that overlaps the back porch period BP of the first period TP1 and the front porch period FP of the second period TP2. However, the disclosure is not limited thereto. In another embodiment, for example, each of the compensation scan signals GC1 to GCi may include the compensation active period SAPa overlapping one of the back porch period BP of the first period TP1 and the front porch period FP of the second period TP2. FIG. 10 illustrates an embodiment where the duration of the compensation active period SAPa is longer than the duration of the second active period AP2. However, the disclosure is not limited thereto. In another embodiment, for example, the duration of the compensation active period SAPa may be the same as the duration of the second active period AP2.

According to embodiments of the disclosure, as a compensation scan signal (or a second scan signal) is activated during a compensation active period in a second period of one frame, a compensation operation in which a third transistor is turned on and a threshold voltage of a first transistor is compensated may be performed even in the second period.

In embodiments of the disclosure, where one frame includes a plurality of second periods, the power consumption of a display device may be reduced as the number of second periods in each of which the compensation active period is provided is adjusted, compared to a case where the compensation active period is provided in all the plurality of second periods.

The invention should not be construed as being limited to the embodiments set forth herein. Rather, these embodiments are provided so that this disclosure will be thorough and complete and will fully convey the concept of the invention to those skilled in the art.

While the invention has been described with reference to embodiments thereof, it will be understood by those of ordinary skill in the art that various changes and modifications in form and details may be made therein without departing from the spirit or scope of the invention as defined by the following claims.

What is claimed is:

1. A display device comprising:
a display panel including a pixel;
a data driver which supplies a data voltage to the pixel; and
a gate driver which supplies a first scan signal and a second scan signal to the pixel,
wherein the pixel includes:
a light emitting element;
a first transistor connected between the light emitting element and a first power line;
a second transistor connected to the first transistor, wherein the second transistor receives the data voltage and the first scan signal; and
a third transistor connected to a control electrode of the first transistor, wherein the third transistor receives the second scan signal,
wherein the data driver supplies the data voltage to the pixel during a first period of a frame and supplies a bias voltage to the pixel during a second period of the frame, and
wherein the second scan signal includes a second active period overlapping the first period and a compensation active period overlapping the second period.

2. The display device of claim 1, wherein the compensation active period has a duration equal to a duration of the second active period.

3. The display device of claim 1, wherein the compensation active period includes a plurality of sub-compensation active periods, and
wherein each of the sub-compensation active periods has a duration equal to a duration of the second active period.

4. The display device of claim 1, wherein the first scan signal includes a first active period which overlaps the first period and the second period, and
wherein the first active period has a duration shorter than a duration of the second active period.

5. The display device of claim 4, wherein the first active period includes a first sub-active period overlapping the second active period or the compensation active period, and a second sub-active period not overlapping the second active period or the compensation active period.

6. The display device of claim 5, wherein a start time point of the first sub-active period follows a start time point of the second active period, and
wherein a start time point of the second sub-active period follows an end time point of the second active period.

7. The display device of claim 1,
wherein the second transistor includes:
a first electrode connected to a data line;
a second electrode connected to a first electrode of the first transistor; and
a control electrode which receives the first scan signal, and
wherein the third transistor includes:
a first electrode connected to the control electrode of the first transistor;
a second electrode connected to a second electrode of the first transistor; and
a control electrode which receives the second scan signal.

8. The display device of claim 7, wherein the gate driver further supplies a third scan signal to the pixel, and
wherein the pixel further includes:
a fourth transistor including a first electrode connected to the control electrode of the first transistor, a second electrode connected to an initialization voltage line, and a control electrode which receives the third scan signal.

9. The display device of claim 1, further comprising:
a light emitting driver which applies an emission control signal to the pixel.

10. The display device of claim 9, wherein the emission control signal includes a first inactive period and a second inactive period which overlap the first period and the second period, respectively, and
wherein the second active period and the compensation active period overlap the first inactive period and the second inactive period, respectively.

11. The display device of claim 1, wherein the gate driver includes:
a first scan circuit which outputs the first scan signal; and
a second scan circuit which outputs the second scan signal.

12. The display device of claim 11, wherein the gate driver further includes:
a masking circuit connected to an output terminal of the second scan circuit to receive the second scan signal, wherein the masking circuit selectively masks an output of the second scan signal in response to a masking signal.

13. The display device of claim 12, wherein the display panel displays an image during a plurality of frames,
wherein each of the plurality of frames includes the first period and the second period,
wherein the masking circuit masks the output of the second scan signal during the second period in response to the masking signal in units of k preset frames, wherein k is an integer equal to or greater than 2.

14. The display device of claim 1, wherein the gate driver further includes:
a scan circuit which outputs a scan signal through an output terminal thereof; and
a switching circuit which receives the scan signal, outputs the scan signal as the first scan signal and the second scan signal during the first period, and outputs the scan signal as the second scan signal during the second period.

15. The display device of claim 14, wherein the switching circuit includes:
a first switching element connected to the output terminal to receive the scan signal, turned on during the first period in response to a first switching signal to output the scan signal as the first scan signal, and turned off during the second period not to output the first scan signal; and
a second switching element connected to the output terminal to receive the scan signal, and turned on during the first period and the second period in response to a second switching signal to output the scan signal as the second scan signal.

16. An electronic device comprising:
a display device which provides an image, comprising:
a display panel including a pixel which displays an image during a plurality of frames;
a data driver which supplies a data voltage to the pixel;
a gate driver which supplies a first scan signal and a second scan signal to the pixel; and
a driving controller which receives an image signal and a control signal, and controls operations of the data driver and the gate driver,
wherein the pixel includes:
a light emitting element;
a first transistor connected between the light emitting element and a first power line;
a second transistor connected to the first transistor, wherein the second transistor receives the data voltage and the first scan signal; and
a third transistor connected to a control electrode of the first transistor, wherein the third transistor receives the second scan signal,
wherein each of the plurality of frames includes a first period and a plurality of second periods,
wherein the data driver supplies the data voltage to the pixel during the first period and supplies a bias voltage to the pixel during the plurality of second periods, and
wherein the second scan signal includes a second active period overlapping the first period and a compensation active period overlapping at least one of the plurality of second periods.

17. The electronic device of claim 16, wherein the gate driver includes:
a first scan circuit which outputs the first scan signal; and
a second scan circuit which outputs the second scan signal.

18. The electronic device of claim 17, wherein the gate driver further includes:
a masking circuit connected to an output terminal of the second scan circuit to receive the second scan signal, wherein the masking circuit selectively masks an output of the second scan signal in response to a masking signal.

19. The electronic device of claim 18, wherein the masking circuit outputs the second scan signal during at least one second period selected from the plurality of second periods in response to the masking signal, and masks the second scan signal in a way such that the second scan signal is not output during remaining second periods.

20. A display device comprising:
a display panel including a pixel;
a data driver which supplies a data voltage to the pixel; and
a gate driver which supplies a first scan signal and a second scan signal to the pixel,
wherein the pixel includes:
a light emitting element;
a first transistor connected between the light emitting element and a first power line;
a second transistor connected to the first transistor, wherein the second transistor receives the data voltage and the first scan signal; and
a third transistor connected to a control electrode of the first transistor, wherein the third transistor receives the second scan signal,
wherein the data supplies the data voltage to the pixel during a first period and supplies a bias voltage to the pixel during a second period,
wherein each of the first period and the second period includes a valid period, a front porch period preceding the valid period, and a back porch period following the valid period, and
wherein the second scan signal includes a second active period overlapping the valid period of the first period, and a compensation active period overlapping at least one selected from the back porch period of the first period and the front porch period of the second period.

21. The display device of claim 20, wherein the compensation active period has a duration equal to a duration of the second active period, or has a longer duration than the duration of the second active period.
